(19) United States
(12) Patent Application Publication
(10) Pub. No.: US 2026/0218088 A1
(43) Pub. Date: Jul. 30, 2026

(54) DETERGENT FORMULATION

(71) Applicants: Rohm and Haas Company, Collegeville, PA (US); Union Carbide Corporation, Seadrift, TX (US)

(72) Inventors: Fanwen Zeng, Audubon, PA (US); Scott Backer, Phoenixville, PA (US); Wei Gao, Fort Washington, PA (US); Inna Shulman, Langhorne, PA (US); Randara Pulukkody, Lansdale, PA (US); Paul Mercando, Pennsburg, PA (US); Wen-Shiue Young, Blue Bell, PA (US); Meng Jing, Collegeville, PA (US)

(21) Appl. No.: 19/151,672

(22) PCT Filed: Feb. 15, 2024
(86) PCT No.: PCT/US2024/015890

§ 371 Date: Jul. 29, 2025

Related U.S. Application Data
(60) Provisional application No. 63/447,649, filed on Feb. 23, 2023.

(51) Int. Cl. C11D 3/37; C11D 3/10; C11D 3/12; C11D 3/20; C11D 3/33; C11D 3/36

(52) U.S. Cl. CPC C11D 3/3788; C11D 3/10; C11D 3/1246; C11D 3/2086; C11D 3/33; C11D 3/361; C11D 3/3707; C11D 3/3761

(57) ABSTRACT

A detergent composition is provided including: a cleaning surfactant; and a dispersant hydrophilic block copolymer, comprising: carboxylic acid polymer segments comprising structural units of a monoethylenically unsaturated carboxylic acid monomer; and poly(alkylene oxide) diol polymer segments, consisting of structural units of a poly(alkylene oxide) diol; wherein 90 to 100 wt % of the poly(alkylene oxide) diol polymer segments are esterified with two structural units of monoethylenically unsaturated carboxylic acid monomer present in the carboxylic acid polymer segments per poly(alkylene oxide) diol polymer segment.

The present invention relates to a detergent formulation. In particular, the present invention relates a detergent formulation, comprising: a cleaning surfactant; and a dispersant hydrophilic block copolymer, comprising: carboxylic acid polymer segments comprising structural units of a monoethylenically unsaturated carboxylic acid monomer; and poly(alkylene oxide) diol polymer segments, consisting of structural units of a poly(alkylene oxide) diol; wherein 90 to 100 wt % of the poly(alkylene oxide) diol polymer segments are esterified with two structural units of monoethylenically unsaturated carboxylic acid monomer present in the carboxylic acid polymer segments per poly(alkylene oxide) diol polymer segment.

In detergent applications, large volumes of ingredients are used. Because these ingredients may eventually enter the environment and reside in subsurface waters, it is desirable for such ingredients to be degradable in order to avoid any environmental concerns. Traditionally, detergents and cleaning agents contained phosphates. The phosphates were added to formulations as detergent builders, acting to sequester alkaline earth metal hardness ions, as encrustation inhibitors and as antiredeposition agents. Despite the fact that the well-known inorganic phosphorus compounds were highly effective and relatively non-toxic, there use in many applications has been discontinued.

Efforts have been ongoing in the detergent industry to convert from polyphosphates to materials such as polycarboxylic acid polymers such as poly(acrylic acids). While polycarboxylic acid polymers and copolymers currently used in detergent and water treatment formulations do not suffer from the same perceived drawbacks as phosphorus containing inorganic builders, the past has taught that it might be desirable for ingredients used in large volume applications which may enter the environment be biodegradable. Unfortunately, most polycarboxylic acid polymers and copolymers useful in detergent and/or water treatment applications are not highly biodegradable.

Some efforts have been made to provide biodegradable water-soluble poly(acrylic acid) copolymers. Notable in this regard is U.S. Pat. No. 5,318,719, in which Hughes et al. teach graft polymers as biodegradable detergent additives. In particular, Hughes et al. teach a class of biodegradable water soluble graft copolymers having building, antifilming, dispersing and threshold crystal inhibiting properties comprising (a) an acid functional monomer and optionally (b) other water soluble, monoethylenically unsaturated monomers copolymerizable with (a) grafted to a biodegradable substrate comprising polyalkylene oxides and/or polyalkoxylated materials. Notwithstanding, the processing methodology taught in U.S. Pat. No. 5,318,719 fails to produce high concentrations of poly(acrylic acid)/poly(alkylene oxide) copolymer.

Accordingly, it would be desirable to have detergents (particularly automatic dish washing detergents) formulated with high purity poly(acrylic acid)/poly(alkylene oxide) copolymers.

The present invention provides a detergent composition comprising: a cleaning surfactant; and a dispersant hydrophilic block copolymer, comprising: carboxylic acid polymer segments comprising structural units of a monoethylenically unsaturated carboxylic acid monomer; and poly(alkylene oxide) diol polymer segments, consisting of structural units of a poly(alkylene oxide) diol; wherein 90 to 100 wt % of the poly(alkylene oxide) diol polymer segments are esterified with two structural units of monoethylenically unsaturated carboxylic acid monomer present in the carboxylic acid polymer segments per poly(alkylene oxide) diol polymer segment.

The present invention provides a detergent composition comprising: a cleaning surfactant; and a dispersant hydrophilic block copolymer, comprising: carboxylic acid polymer segments comprising structural units of a monoethylenically unsaturated carboxylic acid monomer; and poly(alkylene oxide) diol polymer segments, consisting of structural units of a poly(alkylene oxide) diol; wherein 40 to 100 wt % of the dispersant hydrophilic block copolymer is of formula (I)

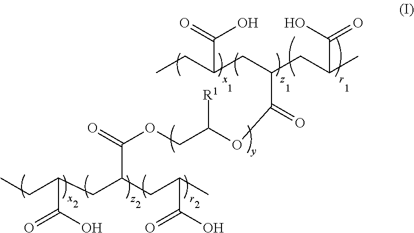

wherein z₁ is 1; wherein x₁ is 0 to 139; wherein r₁ is 0 to 139; wherein x₁+z₁+r₁=7 to 140; wherein z₂ is 1; wherein x₂ is 0 to 139; wherein r₂ is 0 to 139; wherein x₂+z₂+r₂=7 to 140; wherein each R¹ is individually selected from the group consisting of a hydrogen and a C₁₋₃ alkyl group; and wherein y is an average of 4 to 84.

The present invention provides a detergent composition comprising: a cleaning surfactant; and a dispersant hydrophilic block copolymer, comprising: carboxylic acid polymer segments comprising structural units of a monoethylenically unsaturated carboxylic acid monomer; and poly(alkylene oxide) diol polymer segments, consisting of structural units of a poly(alkylene oxide) diol; wherein 40 to 100 wt % of the dispersant hydrophilic block copolymer is of formula (I)

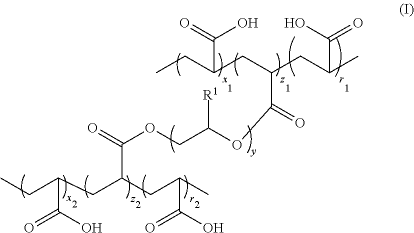

wherein z₁ is 1; wherein x₁ is 0 to 139; wherein r₁ is 0 to 139; wherein x₁+z₁+r₁=7 to 140; wherein z₂ is 1; wherein x₂ is 0 to 139; wherein r₂ is 0 to 139; wherein x₂+z₂+r₂=7 to 140; wherein each R¹ is individually selected from the group consisting of a hydrogen and a C₁₋₃ alkyl group; wherein y is an average of 4 to 84; wherein the molar ratio of poly(alkylene oxide) diol polymer segments to carboxylic acid polymer segments in the dispersant hydrophilic block copolymer is 0.005 to 0.03; wherein the dispersant hydrophilic block copolymer comprises 0 to 60 wt % of residual carboxylic acid polymer segments that remain unesterified with a poly(alkylene oxide) diol polymer segment; and wherein the dispersant hydrophilic block copolymer comprises 0 to 1 wt % of residual poly(alkylene oxide) diol polymer segments that remain unesterified with a carboxylic acid polymer segment.

The present invention provides an automatic dishwashing detergent composition, comprising: 50 to 85 wt %, based on weight of the automatic dishwashing detergent composition, of a builder, wherein the builder is selected from the group consisting of carbonates, bicarbonates, citrates, silicates and mixtures thereof; 0.75 to 7 wt %, based on weight of the automatic dishwashing detergent composition, of a phosphonate; 1.5 to 7.5 wt %, based on weight of the automatic dishwashing detergent composition, of a nonionic surfactant; and 4 to 7 wt %, based on weight of the automatic dishwashing detergent composition, of a dispersant hydrophilic block copolymer, comprising: carboxylic acid polymer segments comprising structural units of a monoethylenically unsaturated carboxylic acid monomer; and poly(alkylene oxide) diol polymer segments, consisting of structural units of a poly(alkylene oxide) diol; wherein 90 to 100 wt % of the poly(alkylene oxide) diol polymer segments are esterified with two structural units of monoethylenically unsaturated carboxylic acid monomer present in the carboxylic acid polymer segments per poly(alkylene oxide) diol polymer segment.

The present invention provides an automatic dishwashing detergent composition, comprising: 50 to 85 wt %, based on weight of the automatic dishwashing detergent composition, of a builder, wherein the builder is selected from the group consisting of carbonates, bicarbonates, citrates, silicates and mixtures thereof; 0.75 to 7 wt %, based on weight of the automatic dishwashing detergent composition, of a phosphonate; 1.5 to 7.5 wt %, based on weight of the automatic dishwashing detergent composition, of a nonionic surfactant; and 4 to 7, based on weight of the automatic dishwashing detergent composition, of a dispersant hydrophilic block copolymer, comprising: a dispersant hydrophilic block copolymer, comprising: carboxylic acid polymer segments comprising structural units of a monoethylenically unsaturated carboxylic acid monomer; and poly(alkylene oxide) diol polymer segments, consisting of structural units of a poly(alkylene oxide) diol; wherein 40 to 100 wt % of the dispersant hydrophilic block copolymer is of formula (I), wherein z₁ is 1; wherein x₁ is 0 to 139; wherein r₁ is 0 to 139; wherein x₁+z₁+r₁=7 to 140; wherein z₂ is 1; wherein x₂ is 0 to 139; wherein r₂ is 0 to 139; wherein x₂+z₂+r₂=7 to 140; wherein each R¹ is individually selected from the group consisting of a hydrogen and a C₁₋₃ alkyl group; and wherein y is an average of 4 to 84.

The present invention provides a method of cleaning an article in an automatic dishwashing machine, comprising: providing at least one article; providing an automatic dishwashing detergent composition of the present intention; and, applying the automatic dishwashing detergent composition to the at least one article in the automatic dishwashing machine.

### DETAILED DESCRIPTION

Surprisingly, it has been found that, detergent compositions comprising a dispersant hydrophilic block copolymer of the present invention, comprising: carboxylic acid polymer segments comprising structural units of a monoethylenically unsaturated carboxylic acid monomer; and poly(alkylene oxide) diol polymer segments, consisting of structural units of a poly(alkylene oxide) diol; wherein 90 to 100 wt % of the poly(alkylene oxide) diol polymer segments are esterified with two structural units of monoethylenically unsaturated carboxylic acid monomer present in the carboxylic acid polymer segments per poly(alkylene oxide) diol polymer segment when incorporated into automatic dishwashing detergent compositions (particularly phosphate-free automatic dishwashing detergent compositions), give surprisingly good spotting and filming performance on a range of surfaces versus conventional dispersant polymers while potentially having a more favorable biodegradability over said conventional dispersant polymers.

Unless otherwise indicated, ratios, percentages, parts, and the like are by weight. Weight percentages (or wt %) in the composition are percentages of weight, i.e., excluding any water that may be present in the composition. Percentages of monomer units in the polymer are percentages of solids weight, i.e., excluding any water present in a polymer emulsion.

As used herein, unless otherwise indicated, the terms “weight average molecular weight” and “Mw” are used interchangeably to refer to the weight average molecular weight as measured in a conventional manner with gel permeation chromatography (GPC)(also sometimes referred to as Size Exclusion Chromatography (SEC)) and conventional standards, such as polyethylene glycol standards. GPC techniques are discussed in detail in Striegel, A. M. et al., Modern Size Exclusion Liquid Chromatography, Practice of Gel Permeation and Gel Filtration (2 ed.) John Wiley & Sons, Inc. (2009), and in Podzimek, S., Light Scattering, Size Exclusion Chromatography and Asymmetric Flow Field Flow Fractionation: Powerful Tools for the Characterization of Polymers, Proteins and Nanoparticles, John Wiley & Sons, Inc. (2011). Weight average molecular weights are reported herein in units of Daltons.

The term “phosphate-free” as used herein and in the appended claims means compositions containing ≤1 wt % (preferably, ≤0.5 wt %; more preferably, ≤0.2 wt %; still more preferably, ≤0.01 wt %; yet still more preferably, ≤0.001 wt %; most preferably, less than the detectable limit) of phosphate (measured as elemental phosphorus).

Preferably, the detergent composition of the present invention is selected from the group consisting of a laundry detergent composition and a dishwashing detergent composition. More preferably, the detergent composition of the present invention is a dishwashing detergent composition. Most preferably, the detergent composition of the present invention is an automatic dishwashing detergent composition.

Preferably, the detergent composition (preferably, the automatic dishwashing detergent composition) of the present invention, comprises: a cleaning surfactant (preferably, 0.5 to 15 wt % (more preferably, 0.75 to 10 wt %; still more preferably, 1 to 8 wt %; most preferably, 1.5 to 7.5 wt %), based on weight of the detergent composition, of the cleaning surfactant); a dispersant hydrophilic block copolymer (preferably, 0.5 to 15 wt % (more preferably, 1 to 10 wt %; still more preferably, 1.5 to 8 wt %; most preferably, 2 to 7 wt %), based on weight of the detergent composition, of the dispersant hydrophilic block copolymer), comprising: carboxylic acid polymer segments comprising structural units of a monoethylenically unsaturated carboxylic acid monomer; and poly(alkylene oxide) diol polymer segments, consisting of structural units of a poly(alkylene oxide) diol; wherein 90 to 100 wt % of the poly(alkylene oxide) diol polymer segments are esterified with two structural units of monoethylenically unsaturated carboxylic acid monomer present in the carboxylic acid polymer segments per poly(alkylene oxide) diol polymer segment; optionally, a builder (preferably, 0 to 99 wt % (more preferably, ≥10 wt %; yet more preferably, ≥20 wt %; still more preferably, ≥25 wt %; most preferably, ≥50 wt %; preferably, ≤95 wt %; more preferably, ≤90 wt %; still more preferably, ≤85 wt %; most preferably, ≤80 wt %), based on weight of the detergent composition, of the builder)(preferably, wherein the builder includes a mixture of at least one carbonate and at least one citrate)); optionally, a phosphonate (preferably, 0 to 15 wt % (more preferably, 0.05 to 10 wt %; still more preferably, 0.5 to 8 wt %; most preferably, 0.75 to 7 wt %), based on weight of the detergent composition, of the phosphonate); optionally, a poly(acrylic acid) homopolymer (preferably, 0 to 15 wt % (more preferably, 0.05 to 10 wt %; still more preferably, 0.5 to 8 wt %; most preferably, 0.75 to 7 wt %), based on weight of the detergent composition, of the poly(acrylic acid) homopolymer); and optionally, a bleaching agent (preferably, 0 to 35 wt % (more preferably, 0 to 30 wt %; still more preferably, 1 to 25 wt %; most preferably, 5 to 20 wt %), based on weight of the detergent composition, of the bleaching agent).

Preferably, the detergent composition (preferably, the automatic dishwashing detergent composition) of the present invention, comprises 0.5 to 15 wt % (preferably, 0.75 to 10 wt %; more preferably, 1 to 8 wt %; most preferably, 1.5 to 7.5 wt %, based on weight of the detergent composition, of a cleaning surfactant. More preferably, the detergent composition (preferably, an automatic dishwashing detergent composition) of the present invention, comprises: 0.5 to 15 wt % (preferably, 0.75 to 10 wt %: more preferably, 1 to 8 wt %; most preferably, 1.5 to 7.5 wt %, based on weight of the detergent composition, of a cleaning surfactant; wherein the cleaning surfactant is selected from the group consisting of anionic surfactants, nonionic surfactants, cationic surfactants, amphoteric surfactants and mixtures thereof. Still more preferably, the detergent composition (preferably, an automatic dishwashing detergent composition) of the present invention, comprises: 0.5 to 15 wt % (preferably, 0.75 to 10 wt %; more preferably, 1 to 8 wt %; most preferably, 1.5 to 7.5 wt %), based on weight of the detergent composition, of a cleaning surfactant; wherein the cleaning surfactant includes a nonionic surfactant. Most preferably, the detergent composition (preferably, an automatic dishwashing detergent composition) of the present invention, comprises: 0.5 to 15 wt % (preferably, 0.75 to 10 wt %; more preferably, 1 to 8 wt %; most preferably, 1.5 to 7.5 wt %), based on weight of the detergent composition, of a cleaning surfactant; wherein the cleaning surfactant includes a nonionic alcohol ethoxylate.

Anionic surfactants include alkyl sulfates, alkyl benzene sulfates, alkyl benzene sulfonic acids, alkyl benzene sulfonates, alkyl polyethoxy sulfates, alkoxylated alcohols, paraffin sulfonic acids, paraffin sulfonates, olefin sulfonic acids, olefin sulfonates, alpha-sulfocarboxylates, esters of alpha-sulfocarboxylates, alkyl glyceryl ether sulfonic acids, alkyl glyceryl ether sulfonates, sulfates of fatty acids, sulfonates of fatty acids, sulfonates of fatty acid esters, alkyl phenols, alkyl phenol polyethoxy ether sulfates, 2-acryloxy-alkane-1-sulfonic acid, 2-acryloxy-alkane-1-sulfonate, beta-alkyloxy alkane sulfonic acid, beta-alkyloxy alkane sulfonate, amine oxides and mixtures thereof. Preferred anionic surfactants include C₈₋₂₀ alkyl benzene sulfates, C₈₋₂₀ alkyl benzene sulfonic acid, C₈₋₂₀ alkyl benzene sulfonate, paraffin sulfonic acid, paraffin sulfonate, alpha-olefin sulfonic acid, alpha-olefin sulfonate, alkoxylated alcohols, C₈₋₂₀ alkyl phenols, amine oxides, sulfonates of fatty acids, sulfonates of fatty acid esters, C₈₋₁₀ alkyl polyethoxy sulfates and mixtures thereof. More preferred anionic surfactants include C₁₂₋₁₆ alkyl benzene sulfonic acid, C₁₂₋₁₆ alkyl benzene sulfonate, C₁₂₋₁₈ paraffin-sulfonic acid, C₁₂₋₁₈ paraffin-sulfonate, C₁₂₋₁₆ alkyl polyethoxy sulfate and mixtures thereof.

Nonionic surfactants include alkoxylates (e.g., polyglycol ethers, fatty alcohol polyglycol ethers, alkylphenol polyglycol ethers, end group capped polyglycol ethers, mixed ethers, hydroxy mixed ethers, fatty acid polyglycol esters and mixtures thereof. Preferred nonionic surfactants include fatty alcohol polyglycol ethers. More preferred nonionic surfactants include secondary alcohol ethoxylates, ethoxylated 2-ethylhexanol, ethoxylated seed oils, butanol caped ethoxylated 2-ethylhexanol and mixtures thereof. Most preferred nonionic surfactants include secondary alcohol ethoxylates.

Preferably, the nonionic surfactant used in the automatic dishwashing detergent composition of the present invention has a formula selected from

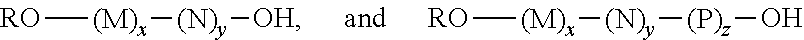

wherein M represents structural units of ethylene oxide, N represents structural units of C₃₋₁₈ 1,2-epoxyalkane, P represents structural units of C₆₋₁₈ alkyl glycidyl ether, x is 5 to 40, y is 0 to 20, z is 0 to 3 and R represents a C₆₋₂₂ linear or branched alkyl group.

Preferably, the nonionic surfactant used in the automatic dishwashing detergent composition of the present invention has a formula selected from

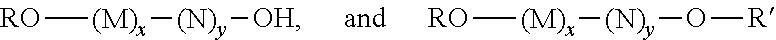

wherein M and N are structural units derived from alkylene oxides (of which one is ethylene oxide); x is 5 to 40; y is 0 to 20; R represents a C₆₋₂₂ linear or branched alkyl group; and R′ represents a group derived from the reaction of an alcohol precursor with a C₆₋₂₂ linear or branched alkyl halide, epoxyalkane or glycidyl ether.

Preferably, the nonionic surfactant used in the automatic dishwashing detergent composition of the present invention has a formula

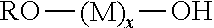

wherein M represents structural units of ethylene oxide and x is at least three (preferably, at least five; preferably, no more than ten; more preferably, no more than eight). Preferably, wherein R and R′ each have at least eight (more preferably, at least ten) carbon atoms.

Cationic surfactants include quaternary surface active compounds. Preferred cationic surfactants include quaternary surface active compounds having at least one of an ammonium group, a sulfonium group, a phosphonium group, an iodonium group and an arsonium group. More preferred cationic surfactants include at least one of a dialkyldimethylammonium chloride and alkyl dimethyl benzyl ammonium chloride. Still more preferred cationic surfactants include at least one of C₁₆₋₁₈ dialkyldimethylammonium chloride, a C₈₋₁₈ alkyl dimethyl benzyl ammonium chloride and dimethyl ditallow ammonium chloride. Most preferred cationic surfactant includes dimethyl ditallow ammonium chloride.

Amphoteric surfactants include betaines, amine oxides, alkylamidoalkylamines, alkyl-substituted amine oxides, acylated amino acids, derivatives of aliphatic quaternary ammonium compounds and mixtures thereof. Preferred amphoteric surfactants include derivatives of aliphatic quaternary ammonium compounds. More preferred amphoteric surfactants include derivatives of aliphatic quaternary ammonium compounds with a long chain group having 8 to 18 carbon atoms. Still more preferred amphoteric surfactants include at least one of C₁₂₋₁₄ alkyldimethylamine oxide, 3-(N,N-dimethyl-N-hexadecyl-ammonio)propane-1-sulfonate, 3-(N,N-dimethyl-N-hexadecylammonio)-2-hydroxypropane-1-sulfonate. Most preferred amphoteric surfactants include at least one of C₁₂₋₁₄ alkyldimethylamine oxide.

Preferably, the detergent composition (preferably, an automatic dishwashing detergent composition) of the present invention, comprises 0.5 to 15 wt % (preferably, 1 to 10 wt %; still more preferably, 1.5 to 8 wt %; most preferably, 2 to 7 wt %), based on weight of the detergent composition, of a dispersant hydrophilic block copolymer, comprising: carboxylic acid polymer segments comprising structural units of a monoethylenically unsaturated carboxylic acid monomer (preferably, wherein the monoethylenically unsaturated carboxylic acid monomer is selected from the group consisting of (meth)acrylic acid, (meth)acryloxypropionic acid, itaconic acid, aconitic acid, maleic acid, fumaric acid, crotonic acid, citraconic acid, monomethyl maleate, monomethyl fumarate, monomethyl itaconate and mixtures thereof; more preferably, wherein the monoethylenically unsaturated carboxylic acid monomer is selected from the group consisting of acrylic acid, methacrylic acid, itaconic acid, crotonic acid and mixtures thereof; still more preferably, wherein the monoethylenically unsaturated carboxylic acid monomer is selected from the group consisting of acrylic acid, methacrylic acid and mixtures thereof; most preferably, wherein the monoethylenically unsaturated carboxylic acid monomer is acrylic acid)(most preferably, wherein the monoethylenically unsaturated carboxylic acid monomer is acrylic acid)(preferably, wherein the carboxylic acid polymer segments comprise 70 to 100 mol % (preferably, 80 to 100 mol %; more preferably, 90 to 100 mol %; still more preferably, 95 to 100 mol %; yet more preferably, 97 to 100 mol %; still yet more preferably, 98 to 100 mol %; yet still more preferably, 99 to 100 mol %; most preferably, 100 mol %) structural units of monoethylenically unsaturated carboxylic acid monomer (preferably, wherein the monoethylenically unsaturated carboxylic acid monomer is selected from the group consisting of acrylic acid, methacrylic acid and mixtures thereof; more preferably, wherein the monoethylenically unsaturated carboxylic acid monomer includes acrylic acid; most preferably, wherein the monoethylenically unsaturated carboxylic acid monomer is acrylic acid)); and poly(alkylene oxide) diol polymer segments, consisting of structural units of a poly(alkylene oxide) diol (preferably, wherein the structural units of poly(alkylene oxide) diol are residues formed from esterification reactions of poly(alkylene oxide) diols according to formula A

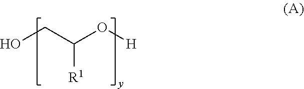

wherein each R¹ is individually selected from the group consisting of a hydrogen and a C₁₋₃ alkyl group (preferably, a hydrogen and a C₁₋₂ alkyl group; more preferably, a hydrogen and a methyl group; most preferably, a hydrogen); and wherein y is an average of 4 to 84 (preferably, 5 to 75; more preferably, 10 to 70; most preferably, 12 to 67)); and wherein 90 to 100 wt % (preferably, 92 to 100 wt %; more preferably, 95 to 100 wt %; still more preferably, 97.5 to 100 wt %; yet more preferably, 98 to 100 wt %; most preferably, 99 to 100 wt %) of the poly(alkylene oxide) diol polymer segments are esterified with two structural units of monoethylenically unsaturated carboxylic acid monomer present in the carboxylic acid polymer segments per poly(alkylene oxide) diol polymer segment (preferably, wherein the poly(alkylene oxide) diol polymer segments form crosslinks within the dispersant hydrophilic block copolymer, wherein the crosslinks are selected from the group consisting of intra crosslinks and inter crosslinks)(intra crosslinks result when the esterifications form on the same carboxylic acid polymer segment; inter crosslinks result when the esterifications form on two separate carboxylic acid polymer segments).

More preferably, the detergent composition (preferably, an automatic dishwashing detergent composition) of the present invention, comprises 0.5 to 15 wt % (preferably, 1 to 10 wt %; still more preferably, 1.5 to 8 wt %; most preferably, 2 to 7 wt %), based on weight of the detergent composition, of a dispersant hydrophilic block copolymer, comprising: carboxylic acid polymer segments comprising structural units of a monoethylenically unsaturated carboxylic acid monomer (preferably, wherein the monoethylenically unsaturated carboxylic acid monomer is selected from the group consisting of (meth)acrylic acid, (meth)acryloxypropionic acid, itaconic acid, aconitic acid, maleic acid, fumaric acid, crotonic acid, citraconic acid, monomethyl maleate, monomethyl fumarate, monomethyl itaconate and mixtures thereof; more preferably, wherein the monoethylenically unsaturated carboxylic acid monomer is selected from the group consisting of acrylic acid, methacrylic acid, itaconic acid, crotonic acid and mixtures thereof; still more preferably, wherein the monoethylenically unsaturated carboxylic acid monomer is selected from the group consisting of acrylic acid, methacrylic acid and mixtures thereof; most preferably, wherein the monoethylenically unsaturated carboxylic acid monomer is acrylic acid)(most preferably, wherein the monoethylenically unsaturated carboxylic acid monomer is acrylic acid)(preferably, wherein the carboxylic acid polymer segments comprise 70 to 100 mol % (preferably, 80 to 100 mol %; more preferably, 90 to 100 mol %; still more preferably, 95 to 100 mol %; yet more preferably, 97 to 100 mol %; still yet more preferably, 98 to 100 mol %; yet still more preferably, 99 to 100 mol %; most preferably, 100 mol %) structural units of monoethylenically unsaturated carboxylic acid monomer (preferably, wherein the monoethylenically unsaturated carboxylic acid monomer is selected from the group consisting of acrylic acid, methacrylic acid and mixtures thereof; more preferably, wherein the monoethylenically unsaturated carboxylic acid monomer includes acrylic acid; most preferably, wherein the monoethylenically unsaturated carboxylic acid monomer is acrylic acid)); and poly(alkylene oxide) diol polymer segments, consisting of structural units of a poly(alkylene oxide) diol (preferably, wherein the structural units of poly(alkylene oxide) diol are residues formed from esterification reactions of poly(alkylene oxide) diols according to formula A

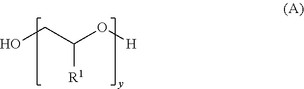

wherein each R¹ is individually selected from the group consisting of a hydrogen and a C₁₋₃ alkyl group (preferably, a hydrogen and a C₁₋₂ alkyl group; more preferably, a hydrogen and a methyl group; most preferably, a hydrogen); and wherein y is an average of 4 to 84 (preferably, 5 to 75; more preferably, 10 to 70; most preferably, 12 to 67)); and wherein 40 to 100 wt % (preferably, 50 to 100 wt %; more preferably, 55 to 100 wt %; still more preferably, 60 to 100 wt %; yet more preferably, 75 to 100 wt %; most preferably, 90 to 100 wt %) of the dispersant hydrophilic block copolymer is of formula (I)

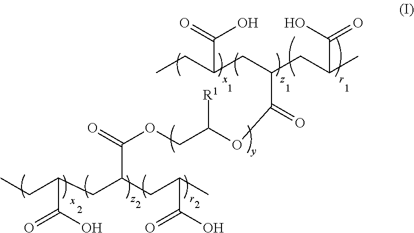

wherein z₁ is 1 to 2 (preferably, 1); wherein x₁ is 0 to 139 (preferably, 0 to 140; more preferably, 0 to 104; most preferably, 0 to 83); wherein r₁ is 0 to 139 (preferably, 0 to 140; more preferably, 0 to 104; most preferably, 0 to 83); wherein x₁+z₁+r₁=7 to 140 (preferably, 21 to 140; more preferably, 28 to 104; most preferably, 48 to 83); wherein z₂ is 1 to 2 (preferably, 1)(preferably, wherein z₁=z₂); wherein x₂ is 0 to 139 (preferably, 0 to 140; more preferably, 0 to 104; most preferably, 0 to 83); wherein r₂ is 0 to 139 (preferably, 0 to 140; more preferably, 0 to 104; most preferably, 0 to 83); wherein x₂+z₂+r₂=7 to 140 (preferably, 21 to 140; more preferably, 28 to 104; most preferably, 48 to 83); wherein each R¹ is individually selected from the group consisting of a hydrogen and a C₁₋₃ alkyl group (preferably, a hydrogen and a C₁₂ alkyl group; more preferably, a hydrogen and a methyl group; most preferably, a hydrogen); and wherein y is an average of 4 to 84 (preferably, 5 to 75; more preferably, 10 to 70; most preferably, 12 to 67)(preferably, the poly(alkylene oxide) diol copolymer segments are esterified at random positions along the carboxylic acid copolymer segments)(optionally, some of the carboxylic acid copolymer segments corresponding to x₁, z₁, r₁ and x₂, z₂, r₂ form a single carboxylic acid copolymer segment, wherein the poly(alkylene oxide) diol copolymer segment esterified thereto forms an internal crosslink within the single carboxylic acid copolymer segment)(preferably, the carboxylic acid copolymer segments corresponding to each x₁, z₁, r₁ and x₂, z₂, r₂ in the dispersant hydrophilic block copolymer are distinct carboxylic acid copolymer segments that are joined together only by the poly(alkylene oxide) diol copolymer segment)(preferably, the dispersant hydrophilic block copolymer comprises less than 5 wt % (preferably, 0 to 3 wt %; more preferably, 0 to 2 wt %; still more preferably, 0 to 1 wt %; yet more preferably, 0 to 0.5 wt %; most preferably, 0 to 0.1 wt %) dispersant hydrophilic block copolymer having a poly(alkylene oxide) diol copolymer segment internal crosslink).

Preferably, the carboxylic acid copolymer segments comprise 0 to 30 mol % (preferably, 0 to 20 mol %; more preferably, 0 to 10 mol %; still more preferably, 0 to 5 mol %; yet more preferably, 0 to 3 mol %; still yet more preferably, 0 to 2 mol %; yet still more preferably, 0 to 1 mol %; most preferably, 0 mol %) of structural units selected from the group consisting of structural units of monoethylenically unsaturated nonionic monomer, structural units of sulfonated monomer and mixtures thereof. More preferably, the carboxylic acid copolymer segments comprise 0 to 30 mol % (preferably, 0 to 20 mol %; more preferably, 0 to 10 mol %; still more preferably, 0 to 5 mol %; yet more preferably, 0 to 3 mol %; still yet more preferably, 0 to 2 mol %; yet still more preferably, 0 to 1 mol %; most preferably, 0 mol %) of structural units selected from the group consisting of structural units of monoethylenically unsaturated nonionic monomer, structural units of sulfonated monomer and mixtures thereof; wherein the monoethylenically unsaturated nonionic monomer is a C₁₄ alkyl (meth)acrylate (preferably, wherein the monoethylenically unsaturated nonionic monomer is selected from the group consisting of a methyl (meth)acrylate, ethyl (meth)acrylate, n-butyl (meth)acrylate, i-butyl (meth)acrylate, t-butyl (meth)acrylate and mixtures thereof; more preferably, methyl (meth)acrylate, ethyl (meth)acrylate, n-butyl (meth)acrylate and mixtures thereof; still more preferably, ethyl (meth)acrylate, n-butyl (meth) acrylate and mixtures thereof; most preferably, ethyl acrylate, butyl acrylate and mixture thereof); and wherein the sulfonated monomer is selected from the group consisting of 2-acrylamido-2-methylpropane sulfonic acid (AMPS), 2-methacrylamido-2-methylpropane sulfonic acid, 4-styrenesulfonic acid, vinyl sulfonic acid, 3-allyloxy sulfonic acid, 2-hydroxy-1-propane sulfonic acid (HAPS), 2-sulfoethyl(meth)acrylic acid, 2-sulfopropyl(meth)acrylic acid, 3-sulfopropyl(meth)acrylic acid, 4-sulfobutyl(meth)acrylic acid and salts thereof (preferably, wherein the sulfonated monomer is 2-acrylamido-2-methylpropane sulfonic acid (AMPS) monomer (preferably, wherein the sulfonated monomer is selected from the group consisting of 2-acrylamido-2-methylpropane sulfonic acid (AMPS), 2-methyacrylamido-2-methylpropane sulfonic acid, vinyl sulfonic acid and salts thereof; more preferably, wherein the sulfonated monomer is selected from the group consisting of 2-acrylamido-2-methylpropane sulfonic acid (AMPS), 2-methyacrylamido-2-methylpropane sulfonic acid and salts thereof; most preferably, wherein the sulfonated monomer is selected from the group consisting of 2-acrylamido-2-methylpropane sulfonic acid (AMPS) and salts thereof).

Preferably, the dispersant hydrophilic block copolymer has a carboxylic acid copolymer segment weight average molecular weight of 500 to 10,000 Daltons per molecule of dispersant hydrophilic block copolymer (preferably, 1,500 to 10,000 Daltons; more preferably, 2,000 to 7,500 Daltons; most preferably, 2,500 to 6,000 Daltons); and the dispersant hydrophilic block copolymer has a poly(alkylene oxide) diol copolymer segment weight average molecular weight of 250 to 5,000 Daltons (preferably, 300 to 4,650 Daltons; more preferably, 600 to 4,200 Daltons; most preferably, 720 to 4,020 Daltons) per molecule of dispersant hydrophilic block copolymer.

Preferably, the dispersant hydrophilic block copolymer has a molar ratio of poly(alkylene oxide) diol polymer segments to carboxylic acid polymer segments of 0.01 to 0.03 (preferably, 0.01 to 0.03; more preferably, 0.01 to 0.029; most preferably, 0.0125 to 0.0285).

Preferably, the dispersant hydrophilic block copolymer of the present invention, comprises 0 to 60 wt % (preferably, 0 to 50 wt %; more preferably, 0 to 45 wt %; still more preferably, 0 to 40 wt %; yet more preferably, 0 to 25 wt %; most preferably, 0 to 10 wt %) of residual carboxylic acid polymer segments that remain unesterified with a poly(alkylene oxide) diol polymer segment.

Preferably, the dispersant hydrophilic block copolymer of the present invention, comprises 0 to 1 wt % (preferably, 0 to 0.5 wt %; more preferably, 0 to 0.25 wt %; still more preferably, 0 to 0.1 wt %; yet more preferably, 0 to 0.01 wt %; most preferably, 0 to 0.001 wt %) of residual poly(alkylene oxide) diol polymer segments that remain unesterified with a carboxylic acid polymer segment.

The dispersant hydrophilic block copolymers can be made using the synthesis described in Syntheses S2-S5 below.

The automatic dishwashing detergent composition of the present invention, optionally further comprises an additive. Preferably, the automatic dishwashing detergent composition of the present invention, further comprises an additive selected from the group consisting of a builder; an alkaline source; a bleaching agent (e.g., sodium percarbonate, sodium perborate); a bleach activator (e.g., tetraacetylethylenediamine (TAED)); a bleach catalyst (e.g., manganese(II) acetate, cobalt(II) chloride, bis(TACN)magnesium trioxide diacetate); an enzyme (e.g., protease, amylase, lipase, or cellulase); a foam suppressant; a coloring agent; a fragrance; an additional builder; an antibacterial agent; a filler; a deposit control polymer and mixtures thereof. More preferably, the automatic dishwashing detergent composition of the present invention, further comprises an additive, wherein the additive is selected from the group consisting of a builder, a carrier (e.g., an aqueous liquid), a bleaching agent, a bleach activator, an enzyme, a filler and mixtures thereof. Still more preferably, the automatic dishwashing detergent composition of the present invention, further comprises an additive, wherein the additive includes a builder, a bleaching agent (e.g., sodium percarbonate, sodium perborate); a bleach activator (e.g., tetraacetylethylenediamine (TAED)) and an enzyme (e.g., protease, amylase, lipase, or cellulase). Most preferably, the automatic dishwashing detergent composition of the present invention, further comprises an additive, wherein the additive includes a builder, wherein the builder includes a carbonate and a citrate; a bleaching agent, wherein the bleaching agent includes sodium percarbonate; a bleach activator, wherein the bleach activator includes tetraacetylethylenediamine (TAED); and an enzyme, wherein the enzyme includes a protease and an amylase.

Preferably, the automatic dishwashing detergent composition of the present invention, further comprises 0 to 99 wt % (more preferably, ≥10 wt %; yet more preferably, ≥20 wt %; still more preferably, ≥25 wt %; most preferably, ≥50 wt %; preferably, ≤95 wt %; more preferably, ≤90 wt %; still more preferably, ≤85 wt %; most preferably, ≤80 wt %), based on weight of the automatic dishwashing detergent composition, of a builder. More preferably, 0 to 99 wt % (more preferably, ≥10 wt %; yet more preferably, ≥20 wt %; still more preferably, ≥25 wt %; most preferably, ≥50 wt %; preferably, ≤95 wt %; more preferably, ≤90 wt %; still more preferably, ≤85 wt %; most preferably, ≤80 wt %), based on weight of the automatic dishwashing detergent composition, of a builder; wherein the builder comprises a mixture of at least one carbonate and at least one citrate. More preferably, the automatic dishwashing detergent composition of the present invention comprises 0 to 99 wt % (more preferably, ≥10 wt %; yet more preferably, ≥20 wt %; still more preferably, ≥25 wt %; most preferably, ≥50 wt %; preferably, ≤95 wt %; more preferably, ≤90 wt %; still more preferably, ≤85 wt %; most preferably, ≤80 wt %), based on weight of the automatic dishwashing detergent composition, of a builder; wherein the builder comprises a mixture of at least one carbonate, at least one citrate and at least one silicate. Most more preferably, the automatic dishwashing detergent composition of the present invention, comprises 0 to 99 wt % (more preferably, ≥10 wt %; yet more preferably, ≥20 wt %; still more preferably, ≥25 wt %; most preferably, ≥50 wt %; preferably, ≤95 wt %; more preferably, ≤90 wt %; still more preferably, ≤85 wt %; most preferably, ≤80 wt %), based on weight of the automatic dishwashing detergent composition, of a builder; wherein the builder comprises a mixture of sodium carbonate, sodium citrate and sodium silicate. Weight percentages of carbonate, citrate and silicate builders are based on the actual weights of the salts, including metal ions.

The term “carbonate(s)” as used herein and in the appended claims refers to alkali metal or ammonium salts of carbonate, bicarbonate and/or sesquicarbonate. Preferably, the carbonate used in the automatic dishwashing detergent composition (if any) is selected from the group consisting of carbonate salts of sodium, potassium and lithium (more preferably, salts of sodium or potassium; most preferably, salts of sodium). Most preferably, the carbonate used in the automatic dishwashing detergent composition (if any) includes at least one of sodium carbonate and sodium bicarbonate. Preferably, when the builder used in the automatic dishwashing detergent composition of the present invention includes carbonate, the automatic dishwashing detergent composition preferably, comprises 0 to 99 wt % (preferably, 10 to 75 wt %; more preferably, 25 to 60 wt %; most preferably 40 to 50 wt %), based on weight of the automatic dishwashing detergent composition, of carbonate.

The term “citrate(s)” as used herein and in the appended claims refers to alkali metal citrates. Preferably, the citrate used in the automatic dishwashing detergent composition (if any) is selected from the group consisting of citrate salts of sodium, potassium and lithium (more preferably, salts of sodium or potassium; most preferably, salts of sodium). More preferably, the citrate used in the automatic dishwashing detergent composition (if any) is sodium citrate. Preferably, when the builder used in the automatic dishwashing detergent composition of the present invention includes citrate, the automatic dishwashing detergent composition preferably, comprises 0 to 99 wt % (preferably, 5 to 75 wt %; more preferably, 10 to 60 wt %; most preferably 20 to 40 wt %), based on weight of the automatic dishwashing detergent composition, of the citrate.

The term “silicate(s)” as used herein and in the appended claims refers to alkali metal silicates. Preferably, the silicate used in the automatic dishwashing detergent composition (if any) is selected from the group consisting of silicate salts of sodium, potassium and lithium (more preferably, salts of sodium or potassium; most preferably, salts of sodium). More preferably, the silicate used in the automatic dishwashing detergent composition (if any) is sodium disilicate. Preferably, the builder used in the automatic dishwashing detergent composition of the present invention includes a silicate. Preferably, when the builder used in the automatic dishwashing detergent composition of the present invention includes a silicate, the automatic dishwashing detergent composition preferably, comprises 0 to 99 wt % (preferably, 0.1 to 10 wt %; more preferably, 0.5 to 7.5 wt %; most preferably 0.75 to 3 wt %), based on weight of the automatic dishwashing detergent composition, of the silicate.

Preferably, the automatic dishwashing detergent composition of the present invention further comprises 0 to 15 wt % (more preferably, 0.05 to 10 wt %; still more preferably, 0.5 to 8 wt %; most preferably, 0.75 to 7 wt %), based on weight of the automatic dishwashing detergent composition, of a phosphonate. More preferably, the automatic dishwashing detergent composition of the present invention comprises 0 to 15 wt % (more preferably, 0.05 to 10 wt %; still more preferably, 0.5 to 8 wt %; most preferably, 0.75 to 7 wt %), based on weight of the automatic dishwashing detergent composition, of a phosphonate; wherein the phosphonate is a low molecular weight having a weight average molecular weight of ≤1,000 Daltons. Still more preferably, the automatic dishwashing detergent composition of the present invention comprises 0 to 15 wt % (more preferably, 0.05 to 10 wt %; still more preferably, 0.5 to 8 wt %; most preferably, 0.75 to 7 wt %), based on weight of the automatic dishwashing detergent composition, of a phosphonate; wherein the phosphonate comprises at least one of 1-hydroxyethylidene-1,1-diphosphonic acid (HEDP) and a salt of 1-hydroxyethylidene-1,1-diphosphonic acid. Most preferably, the automatic dishwashing detergent composition of the present invention comprises 0 to 15 wt % (more preferably, 0.05 to 10 wt %; still more preferably, 0.5 to 8 wt %; most preferably, 0.75 to 7 wt %), based on weight of the automatic dishwashing detergent composition, of a phosphonate; wherein the phosphonate is selected from the group consisting of 1-hydroxyethylidene-1,1-diphosphonic acid (HEDP) and salts thereof.

Preferably, the automatic dishwashing detergent composition of the present invention further comprises 0 to 15 wt % (preferably, 0.05 to 10 wt %; more preferably, 0.5 to 8 wt %; most preferably, 0.75 to 7 wt %), based on weight of the detergent composition, of a poly(acrylic acid) homopolymer). Preferably, the automatic dishwashing detergent composition of the present invention further comprises 0 to 15 wt % (preferably, 0.05 to 10 wt %; more preferably, 0.5 to 8 wt %; most preferably, 0.75 to 7 wt %), based on weight of the detergent composition, of a poly(acrylic acid) homopolymer; wherein the polyacrylic acid homopolymer has a weight average molecular weight of 1,000 to 10,000 Daltons (preferably, ≥1,500 Daltons; more preferably, ≥2,000 Daltons; still more preferably, ≥3,000 Daltons; most preferably, ≥4,000 Daltons; preferably, ≤7,500 Daltons; more preferably, ≤7,000 Daltons; still more preferably, ≤6,000 Daltons; most preferably, ≤5,000 Daltons).

Preferably, the automatic dishwashing detergent composition of the present invention, further comprises 0 to 35 wt % (more preferably, 0 to 30 wt %; still more preferably, 1 to 25 wt %; most preferably, 5 to 20 wt %), based on weight of the automatic dishwashing detergent composition, of a bleaching agent (e.g., sodium percarbonate). The amount of the bleaching agent in the automatic dishwashing detergent composition of the present invention (if any) is preferably at a concentration of 1 to 25 wt % (more preferably, 5 to 20 wt %), based on weight of the automatic dishwashing detergent composition.

Fillers included in tablets or powders are inert, water-soluble substances, typically sodium or potassium salts (e.g., sodium sulfate, potassium sulfate, sodium chloride, potassium chloride). In tablets and powders, fillers are typically present in amounts ranging from 0 wt % to 75 wt %. Fillers included in gel formulations typically include those mentioned for use in tablets and powders and also water. Fragrances, dyes, foam suppressants, enzymes and antibacterial agents usually total no more than 10 wt %, alternatively no more than 5 wt %, of the automatic dishwashing detergent composition.

The automatic dishwashing detergent composition of the present invention, optionally further comprises: an alkaline source. Suitable alkaline sources include, without limitation, alkali metal carbonates and alkali metal hydroxides, such as sodium or potassium carbonate, bicarbonate, sesquicarbonate, sodium, lithium, or potassium hydroxide, or mixtures of the foregoing. Sodium hydroxide is preferred. The amount of alkaline source in the automatic dishwashing detergent composition of the present invention (if any) is at least 1 wt % (preferably, at least 20 wt %) and up to 80 wt % (preferably, up to 60 wt %), based on weight of the automatic dishwashing detergent composition.

The automatic dishwashing detergent composition of the present invention, optionally further comprises: a bleach activator (e.g., tetraacetylethylenediamine (TAED)). The amount of the bleach activator in the automatic dishwashing detergent composition of the present invention (if any) is preferably at a concentration of 1 to 10 wt % (more preferably, 2.5 to 7.5 wt %), based on weight of the automatic dishwashing detergent composition.

Preferably, the automatic dishwashing detergent composition of the present invention comprises ≤1 wt % (preferably, ≤0.5 wt %; more preferably, ≤0.2 wt %; still more preferably, ≤0.1 wt %; yet still more preferably, ≤0.01 wt %; most preferably, <the detectable limit), based on weight of the automatic dishwashing detergent composition, of phosphate (measured as elemental phosphorus). Preferably, the automatic dishwashing detergent composition of the present invention is phosphate free.

Preferably, the automatic dishwashing detergent composition of the present invention comprises ≤1 wt % (preferably, ≤0.5 wt %; more preferably, ≤0.2 wt %; still more preferably, ≤0.1 wt %; yet still more preferably, ≤0.01 wt %; most preferably, <the detectable limit), based on weight of the automatic dishwashing detergent composition, of builders selected from the group consisting of nitrilotriacetic acid; ethylenediaminetetraacetic acid; diethylenetriaminepentaacetic acid; glycine-N,N-diacetic acid; methyl glycine-N,N-diacetic acid; 2-hydroxyethyliminodiacetic acid; glutamic acid-N,N-diacetic acid; 3-hydroxy-2,2′-iminodissuccinate; S,S-ethylenediaminedisuccinate aspartic acid-diacetic acid; N,N′-ethylene diamine disuccinic acid; iminodisuccinic acid; aspartic acid; aspartic acid-N,N-diacetic acid; beta-alaninediacetic acid; polyaspartic acid; salts thereof and mixtures thereof. Most preferably, the automatic dishwashing detergent composition of the present invention contains 0 wt % of builders selected from the group consisting of nitrilotriacetic acid; ethylenediaminetetraacetic acid; diethylenetriaminepentaacetic acid; glycine-N,N-diacetic acid; methyl glycine-N,N-diacetic acid; 2-hydroxyethyliminodiacetic acid; glutamic acid-N,N-diacetic acid; 3-hydroxy-2,2′-iminodissuccinate; S,S-ethylenediaminedisuccinate aspartic acid-diacetic acid; N,N′-ethylene diamine disuccinic acid; iminodisuccinic acid; aspartic acid; aspartic acid-N,N-diacetic acid; beta-alaninediacetic acid; polyaspartic acid; salts thereof and mixtures thereof.

Preferably, the automatic dishwashing detergent composition of the present invention has a pH (at 1 wt % in water) of at least 7 (preferably, ≥9; more preferably, ≥9.5). Preferably, the automatic dishwashing detergent composition of the present invention has a pH (at 1 wt % in water) of no greater than 13.

Preferably, the automatic dishwashing detergent composition of the present invention can be formulated in any typical form, e.g., as a tablet, powder, block, monodose, sachet, paste, liquid or gel. More preferably, the automatic dishwashing detergent composition of the present invention is formulated as one of a tablet, a powder, a block, a paste or a gel. Most preferably, the automatic dishwashing detergent composition of the present invention is formulated as a powder.

Preferably, the automatic dishwashing detergent compositions of the present invention are useful for cleaning ware, such as eating and cooking utensils, dishes, in an automatic dishwashing detergent machine.

Preferably, the automatic dishwashing detergent composition of the present invention are suitable for use under typical operating conditions. For example, when used in an automatic dishwashing detergent machine, typical water temperatures during the washing process preferably are from 20° C. to 85° C., preferably 30° C. to 70° C. Typical concentrations for the automatic dishwashing detergent composition as a percentage of total liquid in the dishwasher preferably are from 0.1 to 1 wt %, preferably from 0.2 to 0.7 wt %. With selection of an appropriate product form and addition time, the automatic dishwashing detergent compositions of the present invention may be present in the prewash, main wash, penultimate rinse, final rinse, or any combination of these cycles.

Preferably, the method of cleaning an article in an automatic dishwashing detergent machine of the present invention, comprises: providing at least one article (e.g., cookware, bakeware, tableware, dishware, flatware and/or glassware; preferably, wherein the at least one article includes glassware); providing an automatic dishwashing detergent composition of the present invention; and applying the automatic dishwashing detergent composition to the at least one article (preferably, in an automatic dishwasher).

Preferably, the method of cleaning an article in an automatic dishwashing detergent machine of the present invention, comprises: (i) providing at least one article (e.g., cookware, bakeware, tableware, dishware, flatware and/or glassware; preferably, wherein the at least one article includes glassware); (ii) providing an automatic dishwashing detergent composition of the present invention, wherein the automatic dishwashing detergent composition provided, comprises: 50 to 85 wt % of a builder, wherein the builder is selected from the group consisting of carbonates, bicarbonates, citrates, silicates and mixtures thereof and wherein the builder includes a mixture of at least one carbonate and at least one citrate; 0.75 to 7 wt % of a phosphonate; 1.5 to 7.5 wt % of a nonionic surfactant; and 4 to 7 wt % of a dispersant hydrophilic block copolymer, comprising: carboxylic acid polymer segments comprising structural units of a monoethylenically unsaturated carboxylic acid monomer; and poly(alkylene oxide) diol polymer segments, consisting of structural units of a poly(alkylene oxide) diol; wherein 90 to 100 wt % of the poly(alkylene oxide) diol polymer segments are esterified with two structural units of monoethylenically unsaturated carboxylic acid monomer present in the carboxylic acid polymer segments per poly(alkylene oxide) diol polymer segment.

Some embodiments of the present invention will now be described in detail in the following Examples.

### Synthesis S1: Preparation of Poly(Acrylic Acid)

To a 2 liter, 4 neck round bottom reactor equipped with overhead stirrer, thermocouple, heating mantle, adapter inlet, Claisen head fitter with a water condenser and nitrogen inlet was added deionized water (312.50 g). The reactor contents were heated to 95° C. under nitrogen. A monomer mixture was prepared by mixing deionized water (158.00 g) and acrylic acid (1,090.91 g). A cofeed catalyst solution was prepared by mixing sodium persulfate (21.6 g) and deionized water (133.06 g). A chain regulator mixture was prepared by mixing sodium hydrogen sulfite monohydrate (105.98 g) with deionized water (347 g). Chain regulator mixture (168 g) was charged to the reactor using an addition funnel over 10 minutes. The temperature set point was adjusted to 85° C. Once the reactor contents reached 85° C., the cofeed catalyst solution feed to the reactor was initiated and continued for 93 minutes. One minute after initiation of the cofeed catalyst solution feed, the monomer mixture and chain regulator feeds were started simultaneously and continued for 90 minutes. The initial exotherm was noticed to reach up to 95° C., but the temperature stabilized and was maintained at 93° C. for the duration of the reactant feeds. The reactor contents were maintained at 93° C. for another 15 minutes to finish the reaction. The reactor was then vented and cooled to 70° C. Then deionized water (19.98 g) was added to the reactor contents. The reactor contents were allowed to continue cooling to ambient temperature. Once the temperature of the reactor contents fell below 40° C., the product was recovered. The product had a solids level of 57.13 wt %, a pH of 2.47 and a Tg of 77.05° C. Based on aqueous gel permeation chromatography (GPC) analysis, the product had a weight average molecular weight of 1,899 Daltons and a number average molecular weight of 660 Daltons.

### Syntheses S2-S5: Poly(Acrylic Acid)/Poly(Ethylene Oxide) Diol Copolymer

The poly(acrylic acid)/poly(ethylene oxide) diol copolymers of Syntheses S2-S5 were prepared according to the following procedure. To a 25 mL scintillation vial equipped with a small magnetic stirrer was added (A) a polyacrylic acid homopolymer having a weight average molecular weight of 1,800 Daltons (57.13 wt % in water, 18.42 g) prepared according to Synthesis S1; followed by the addition of poly(ethylene oxide) diol (7.02 g) having the weight average molecular weight as noted in TABLE 1. The vial contents were then heated to 70° C. while stirring at 500 rpm for at least 1 hour. Once they were clear and well mixed, the vial contents were poured into small aluminum pan. The aluminum pan was then covered with a piece of aluminum foil and secured by folding the edges of the aluminum foil over the pan. The aluminum foil was then punctured with a syringe to create small holes. The aluminum pan was then placed into a vacuum oven at 30 mm Hg vacuum with a set point temperature of 120° C. overnight. The aluminum pan was then removed from the oven and allowed to cool. Upon cooling, the product was removed from the aluminum pan and collected.

TABLE 1

| | Polymer (B) | PEG:PAA |
|---|---|---|
| Example | (Daltons) | Molar eq. |
| S2 | 3,350 | 0.0282 |
| S3 | 300 | 0.0282 |
| S4 | 4,000 | 0.0282 |
| S5 | 1,000 | 0.0282 |

### Synthesis S6: AA/mPEG Copolymer

A poly(acrylic acid)/poly(ethylene glycol) methyl ether (mPEG) monol copolymer was prepared according to Synthesis S2 with the substitution of a poly(ethylene glycol) methyl ether (mPEG) monol having a weight average molecular weight of 2,000 Daltons for the poly(ethylene oxide) diol.

### Synthesis S7: AA/MPEGMA Copolymer

To a 2 liter, 4 neck round bottom reactor equipped with overhead stirrer, thermocouple, heating mantle, adapter inlet, Claisen head fitted with a water condenser and nitrogen inlet was charged deionized water (499.80 g) and phosphorus acid (2.2 g). The reactor contents were heated to 100° C. under nitrogen. A monomer mixture containing acrylic acid (174.12 g) and a 50% aqueous solution of mehoxypolyethylene glycol methacrylate having a weight average molecular weight of 2,000 (MPEGMA) (335.24 g) was then metered into the reactor over 5 hours followed by a deionized water rinse. A catalyst cofeed solution of ammonium persulfate (18.37 g) and deionized water (96.90 g) was prepared. A 40% aqueous sodium hydrogen sulfite chain regulator solution (46.24 g) was prepared. The catalyst cofeed solution and the chain regulator solution were concurrently added to the reactor over 5 hours with addition of the monomer mixture as the reactor temperature was maintained at 100° C. After completion of the reactant feeds, the reactor contents were stirred for 2 hours while maintaining a temperature of 100° C. The reactor contents were then cooled to room temperature and adjusted to pH of 7.2 by adding a 50% aqueous solution of sodium hydroxide (190.40 g) over 1 hour. The contents of the reactor were transferred to a storage bottle along with a reactor rinse of deionized water (190.40 g). The product polymer had a solids content of 25.91 wt % and a pH of 7.78.

Based on gel permeation chromatography (GPC) analysis, the product polymer had a weight average molecular weight of 4,336 Daltons and a number average molecular weight of 1,195 Daltons. The product polymer was determined by two dimensional liquid chromatography analysis to primarily consist of a copolymer of acrylic acid and MPEGMA.

Synthesis S8: Poly(Acrylic Acid) Polymerized in Presence of Poly(Ethylene Glycol) (Following Process Exemplified in U.S. Pat. No. 5,318,719)

To a two liter, 4 neck flask equipped with a mechanical stirrer, reflux condenser, and inlets for the gradual addition of the monomers, caustic solution and initiator solution were added deionized water (380.0 g), a 0.15 wt % copper (II) sulfate pentahydrate aqueous solution (25.3 g) and polyethylene glycol having a weight average molecular weight of 3,350 Daltons (152.0 g). The flask contents were heated to reflux. Then glacial acrylic acid (383.84 g), an initiator solution of 30% hydrogen peroxide (126.67 g) and a 50% aqueous solution of sodium hydroxide (316.92 g) were added linearly and separately to the flask contents over two hours. Once the additions were complete, the system was maintained at reflux for an additional twenty minutes. The system was then cooled to 60° C. Then a 50% aqueous solution of sodium hydroxide (76.0 g) was added to the flask contents as a post neutralization.

Based on gel permeation chromatography (GPC) analysis, the product has a weight average molecular weight of 18,067 Daltons and a number average molecular weight of 3,370 Daltons. The product was determined by two dimensional liquid chromatography analysis to primarily consist of two separate homopolymer with a small amount of poly(acrylic acid)/poly(ethylene glycol) copolymer.

### Comparative Examples CF1-CF2 and Example F1: Dishwashing Formulations

Dishwashing compositions were prepared in each of Comparative Examples CF1-CF2 and Example F1 having the component formulations identified in TABLE 2.

TABLE 2

| | Concentration on | | |
|---|---|---|---|
| | solids basis (wt %) | | |
| Ingredient | CF1 | CF2 | F1 |
| Sodium Carbonate | 28.09 | 29.81 | 27.57 |
| Sodium Citrate | 28.09 | 29.81 | 27.57 |
| Sodium Percarbonate | 14.04 | 14.91 | 13.79 |
| Silicate^{a} | 1.22 | 1.29 | 1.19 |
| Polyethylene glycol^{b} | 3.74 | 3.97 | 3.68 |
| Benzotriazole | 0.47 | 0.50 | 0.46 |
| Hydrated silice^{c} | 0.19 | 0.20 | 0.18 |
| HEDP^{d} | 0 | 0 | 0 |
| TAED | 3.74 | 3.97 | 3.68 |
| Nonionic Surfactant^{e} | 5.91 | 6.28 | 5.81 |
| Blend of protease and amylase^{f} | 2.81 | 2.98 | 2.76 |
| Dispersant Polymer 1^{g} | 0 | 6.28 | 0 |
| Dispersant Polymer 2^{h} | 11.70 | 0 | 0 |
| Synthesis S4 | 0 | 0 | 13.31 |

^{a}Britesil ™ H 20 sodium silicate from PQ Corporation
^{b}Carbowax ™ Polyethylene Glycol (PEG) 8000 from The Dow Chemical Company
^{c}SIPERNAT ® 22 S form Evonik
^{d}Cublen K 8514 GR 1-Hydroxyethane-1,1-diphosphonic acid from Zschimmer & Schwarz
^{e}Dowfax ™ 20B102 nonionic linear alcohol alkoxylate from The Dow Chemical Company
^{f}Intensa ® Evity® 145 T from Novozymes
^{g}Acusol ™ 588G sulfonated acrylic copolymer from The Dow Chemical Company
^{h}Acusol ™ 902N acrylic acid homopolymer from The Dow Chemical Company

### Comparative Examples CF3-CF4 and Examples F2-F5: Dishwashing formulations PG

Dishwashing compositions were prepared in each of Comparative Examples CF3-CF4 and Examples F2-F5 having the component formulations identified in TABLE 3.

TABLE 3

| | Concentration on solids basis (wt %) | | | | | |
|---|---|---|---|---|---|---|
| Ingredient | CF3 | CF4 | F2 | F3 | F4 | F5 |
| Sodium Carbonate | 30.00 | 30.00 | 30.00 | 30.00 | 30.00 | 30.00 |
| Sodium Citrate | 30.00 | 30.00 | 30.00 | 30.00 | 30.00 | 30.00 |
| Sodium Percarbonate | 15.00 | 15.00 | 15.00 | 15.00 | 15.00 | 15.00 |
| Silicate^{a} | 1.30 | 1.30 | 1.30 | 1.30 | 1.30 | 1.30 |
| Polyethylene glycol^{b} | 4.00 | 4.00 | 4.00 | 4.00 | 4.00 | 4.00 |
| Benzotriazole | 0.50 | 0.50 | 0.50 | 0.50 | 0.50 | 0.50 |
| Hydrated silice^{c} | 0.20 | 0.20 | 0.20 | 0.20 | 0.20 | 0.20 |
| HEDP^{d} | 0.00 | 0.00 | 0.00 | 0.00 | 0.00 | 0.00 |
| TAED | 4.00 | 4.00 | 4.00 | 4.00 | 4.00 | 4.00 |
| Nonionic Surfactant^{e} | 6.00 | 6.00 | 6.00 | 6.00 | 6.00 | 6.00 |
| Blend of protease and amylase^{f} | 3.00 | 3.00 | 3.00 | 3.00 | 3.00 | 3.00 |
| Dispersant Polymer 1^{g} | 0 | 6.00 | 0 | 0 | 0 | 0 |
| Dispersant Polymer 2^{h} | 6.00 | 0 | 0 | 0 | 0 | 0 |
| Synthesis S2 | 0 | 0 | 6.00 | 0 | 0 | 0 |
| Synthesis S3 | 0 | 0 | 0 | 6.00 | 0 | 0 |
| Synthesis S4 | 0 | 0 | 0 | 0 | 6.00 | 0 |
| Synthesis S5 | 0 | 0 | 0 | 0 | 0 | 6.00 |

^{a}Britesil ™ H 20 sodium silicate from PQ Corporation
^{b}Carbowax ™ Polyethylene Glycol (PEG) 8000 from The Dow Chemical Company
^{c}SIPERNAT ® 22 S form Evonik
^{d}Cublen K 8514 GR 1-Hydroxyethane-1,1-diphosphonic acid from Zschimmer & Schwarz
^{e}Dowfax ™ 20B102 nonionic linear alcohol alkoxylate from The Dow Chemical Company
^{f}Intensa ® Evity ® 145 T from Novozymes
^{g}Acusol ™ 588G sulfonated acrylic copolymer from The Dow Chemical Company
^{h}Acusol ™ 902N acrylic acid homopolymer from The Dow Chemical Company

### Comparative Examples CF5-CF8 and Examples F6-F7: Dishwashing Formulations

Dishwashing compositions were prepared in each of Comparative Examples CF5-CF8 and Examples F6-F7 having the component formulations identified in TABLE 4.

TABLE 4

| | Concentration on solids basis (wt %) | | | | | |
|---|---|---|---|---|---|---|
| Ingredient | CF5 | CF6 | CF7 | CF8 | F6 | F7 |
| Sodium Carbonate | 25 | 25 | 25 | 25 | 25 | 25 |
| Sodium Citrate | 30 | 30 | 30 | 30 | 30 | 30 |
| Sodium Percarbonate | 15 | 15 | 15 | 15 | 15 | 15 |
| Silicate^{a} | 3 | 3 | 3 | 3 | 3 | 3 |
| Polyethylene glycol^{b} | 4 | 4 | 4 | 4 | 4 | 4 |
| HEDP^{c} | 4 | 4 | 4 | 4 | 4 | 4 |
| TAED | 4 | 4 | 4 | 4 | 4 | 4 |
| Nonionic Surfactant^{e} | 6 | 6 | 6 | 6 | 6 | 6 |
| Blend of protease and amylase^{f} | 3 | 3 | 3 | 3 | 3 | 3 |
| Synthesis S1 | 6 | 0 | 0 | 0 | 0 | 0 |
| Synthesis S2 | 0 | 0 | 0 | 0 | 6 | 0 |
| Synthesis S3 | 0 | 0 | 0 | 0 | 0 | 6 |
| Synthesis S6 | 0 | 0 | 0 | 6 | 0 | 0 |
| Synthesis S7 | 0 | 6 | 0 | 0 | 0 | 0 |
| Synthesis S8 | 0 | 0 | 6 | 0 | 0 | 0 |

^{a}Britesil ™ H 20 sodium silicate from PQ Corporation
^{b}Carbowax ™ Polyethylene Glycol (PEG) 8000 from The Dow Chemical Company
^{c}Cublen K 8514 GR 1-Hydroxyethane-1,1-diphosphonic acid from Zschimmer & Schwarz
^{d}Dowfax ™ 20B102 nonionic linear alcohol alkoxylate from The Dow Chemical Company
^{e}Intensa ® Evity ® 145 T from Novozymes

### Procedure for Preparing Food Soil

The STIWA food soil described in TABLE 5 was prepared by the following procedure.
a) Bringing the water to a boil.
b) Mixing in a paper cup the instant gravy, the benzoic acid and the potato starch; and then adding the mixture to the boiling water.
c) Adding the milk and margarine to the product of (b).
d) Letting the product of (c) cool down to approximately 40° C.
e) Adding cooled mixture from (d) to a kitchen mixer (Polytron).
f) Combining in another paper cup, the egg yolk, the ketchup and the mustard and mixing with a spoon.
g) Adding the product of (f) to the mixture of (e) in the blender with continuous stirring.
h) Letting the product of (g) stir in the blender for 5 minutes.
i) While stirring the product of (h) remove 50 g aliquots of the product food soil mixture and place in wide mouth vials
j) The 50 g aliquots are then placed in a freezer.
k) A 50 g aliquots of frozen food soil of (j) is placed into the dishwasher at beginning of the main wash.

TABLE 5

| Ingredient | wt % |
|---|---|
| Water | 70.9 |
| Margarine | 10.1 |
| Gravy Powder | 2.5 |
| Potato Starch | 0.5 |
| Benzoic Acid | 0.1 |
| Egg Yolk | 5.8 |
| Mustard | 2.5 |
| Ketchup | 2.5 |
| Milk | 5.1 |

### Dishwashing Test Conditions

Machine: Miele SS-ADW, Model G1223SC Labor. Wash at 65° C.-30 min wash cycle, followed by two rinse cycles with a rinse water temperature of 65° C. and a final 30 minute drying step. After the drying cycle was complete, the dishwasher door was opened for 30 minutes to allow the steam to evaporate. Water: initial water supplied to the dishwasher had a total water hardness of 40° fH hardness, Ca²⁺:Mg²⁺=3:1 and a temporary water hardness of 27° fH. Food soil: 50 g of the composition noted in TABLE 3 was introduced to the wash liquor frozen in a cup. Each dishwashing composition from Comparative Examples CF1-CF8 and Examples F1-F7 were tested. The food soil was added at the beginning of the wash cycle. The test detergents were also charged to the dishwasher at the beginning of the wash cycle. The test detergents were each dosed at 17 g per wash (based on solids). The number of wash cycles used in this experiment to generate filming and spotting was 14.

### Schott® Glass Evaluation

After 14 wash cycles under the above dishwashing test conditions, the Schott© Glasses were dried in open air for at least 18 hours. After drying in open air following the 14^{th} wash, filming and spotting ratings were determined in a light box with controlled illumination from below. Schott® tumblers were rated for filming and spotting according to ASTM method ranging from 1 (no film/spots) to 5 (heavily filmed/spotted). An average value of 1 to 5 for filming and spotting was determined as reported in TABLES 6-8.

TABLE 6

| | Fourteenth Cycle Score | |
|---|---|---|
| Composition | Filming | Spotting |
| Comp. Example CF1 | 5.0 | 4.0 |
| Comp. Example CF2 | 5.0 | 3.7 |
| Example F1 | 1.3 | 3.9 |

TABLE 7

| | Fourteenth Cycle Score | |
|---|---|---|
| Composition | Filming | Spotting |
| Comp. Example CF3 | 4.1 | 1.2 |
| Comp. Example CF4 | 1.7 | 3.9 |
| Example F2 | 2.8 | 1.1 |
| Example F3 | 2.8 | 3.7 |
| Example F4 | 5.0 | 2.3 |
| Example F5 | 2.5 | 3.5 |

TABLE 8

| | Fourteenth Cycle Score | |
|---|---|---|
| Composition | Filming | Spotting |
| Comp. Example CF5 | 2.9 | 1.8 |
| Comp. Example CF6 | 1.1 | 1.5 |
| Comp. Example CF7 | 5.0 | 1.8 |
| Comp. Example CF8 | 2.3 | 1.1 |
| Example F6 | 1.3 | 1.6 |
| Example F7 | 2.7 | 1.3 |

### 304 Polished Stainless Steel Coupons Evaluation

After 14 wash cycles under the above dishwashing test conditions, polished 304 stainless steel coupons were dried in open air for at least 18 hours. After drying in open air filming and spotting ratings were determined in a light box with controlled illumination. Polished 304 stainless steel coupons were rated for filming and spotting ranging from 1 (no film/spots) to 5 (heavily filmed/spotted). An average value of 1 to 5 for filming and spotting was determined as reported in TABLES 9-11.

TABLE 9

| | Fourteenth Cycle Score | |
|---|---|---|
| Composition | Filming | Spotting |
| Comp. Example CF1 | 1.6 | 3.7 |
| Comp. Example CF2 | 3.1 | 1.5 |
| Example F1 | 1.0 | 1.8 |

TABLE 10

| | Fourteenth Cycle Score | |
|---|---|---|
| Composition | Filming | Spotting |
| Comp. Example CF3 | 1.5 | 2.7 |
| Comp. Example CF4 | 2.6 | 1.8 |
| Example F2 | 1.7 | 2.3 |
| Example F3 | 1.0 | 3.2 |
| Example F4 | 1.0 | 2.4 |
| Example F5 | 1.1 | 2.4 |

TABLE 11

| | Fourteenth Cycle Score | |
|---|---|---|
| Composition | Filming | Spotting |
| Comp. Example CF5 | 2.8 | 1.2 |
| Comp. Example CF6 | 1.0 | 1.5 |
| Comp. Example CF7 | 4.0 | 1.2 |
| Comp. Example CF8 | 1.0 | 1.1 |
| Example F6 | 1.0 | 1.9 |
| Example F7 | 1.0 | 1.1 |

### Acrylic Poly(Styrent-Acrylic) Clear Plastic Drinkware Evaluation

After 14 wash cycles under the above dishwashing test conditions, plastic drinkware was dried in open air for at least 18 hours. After drying in open air filming and spotting ratings were determined in a light box with controlled illumination. Plastic drinkware was rated for filming and spotting ranging from 1 (no film/spots) to 5 (heavily filmed/spotted). An average value of 1 to 5 for filming and spotting was determined as reported in TABLES 12-14.

TABLE 12

| | Fourteenth Cycle Score | |
|---|---|---|
| Composition | Filming | Spotting |
| Comp. Example CF1 | 5.0 | 1.0 |
| Comp. Example CF2 | 5.0 | 1.0 |
| Example F1 | 1.7 | 3.7 |

TABLE 13

| | Fourteenth Cycle Score | |
|---|---|---|
| Composition | Filming | Spotting |
| Comp. Example CF3 | 5.0 | 1.0 |
| Comp. Example CF4 | 5.0 | 1.0 |
| Example F2 | 5.0 | 1.0 |
| Example F3 | 5.0 | 1.0 |
| Example F4 | 5.0 | 1.0 |
| Example F5 | 5.0 | 1.0 |

TABLE 14

| | Fourteenth Cycle Score | |
|---|---|---|
| Composition | Filming | Spotting |
| Comp. Example CF5 | 5.0 | 5.0 |
| Comp. Example CF6 | 2.2 | 1.7 |
| Comp. Example CF7 | 4.7 | 3.4 |
| Comp. Example CF8 | 3.1 | 5.0 |
| Example F6 | 2.4 | 4.3 |
| Example F7 | 3.0 | 5.0 |

### Additional Plastic Test Substrates Evaluation

After 14 wash cycles under the above dishwashing test conditions, additional plastic substrates—an opaque plastic poly(high density polyethylene) lid from a food storage container (OPL), a blue translucent plastic poly(propylene) lid from a ZIPLOC® food storage container (Ziploc) and a white translucent plastic poly(propylene) lid from a Ny-Hi® food storage container (Ny-Hi)—were dried in open air for at least 18 hours. After drying in open air filming and spotting ratings were determined in a light box with controlled illumination. Additional plastic substrates were rated for filming and spotting ranging from 1 (no film/spots) to 5 (heavily filmed/spotted). An average value of 1 to 5 for filming and spotting was determined as reported in TABLES 15-17.

TABLE 15

| | Fourteenth Cycle Score | | | | | |
|---|---|---|---|---|---|---|
| | OPL | | Ziploc | | Ny-Hi | |
| Composition | Film | Spot | Film | Spot | Film | Spot |
| Comp. Example CF1 | 2.6 | 1.4 | 5.0 | 1.0 | 5.0 | 1.0 |
| Comp. Example CF2 | 4.3 | 1.2 | 5.0 | 1.0 | 5.0 | 1.0 |
| Example F1 | 1.0 | 1.3 | 1.0 | 2.4 | 1.5 | 1.8 |

TABLE 16

| | Fourteenth Cycle Score | | | | | |
|---|---|---|---|---|---|---|
| | OPL | | Ziploc | | Ny-Hi | |
| Composition | Film | Spot | Film | Spot | Film | Spot |
| Comp. Example CF3 | 1.7 | 1.3 | 3.0 | 2.0 | 5.0 | 2.6 |
| Comp. Example CF4 | 4.8 | 1.3 | 5.0 | 1.0 | 5.0 | 1.4 |
| Example F2 | 3.1 | 1.7 | 5.0 | 1.0 | 5.0 | 1.0 |
| Example F3 | 1.0 | 1.3 | 1.7 | 2.1 | 4.6 | 2.0 |
| Example F4 | 3.4 | 1.6 | 5.0 | 1.0 | 5.0 | 1.0 |
| Example F5 | 1.0 | 1.4 | 3.2 | 2.8 | 3.2 | 2.0 |

TABLE 17

| | Fourteenth Cycle Score | | | | | |
|---|---|---|---|---|---|---|
| | OPL | | Ziploc | | Ny-Hi | |
| Composition | Film | Spot | Film | Spot | Film | Spot |
| Comp. Example CF5 | 1.5 | 1.3 | 1.4 | 2.8 | 1.0 | 3.7 |
| Comp. Example CF6 | 1.1 | 1.1 | 1.3 | 1.5 | 2.4 | 1.7 |
| Comp. Example CF7 | 1.4 | 1.3 | 1.2 | 2.5 | 2.5 | 2.0 |
| Comp. Example CF8 | 1.0 | 1.2 | 1.9 | 2.1 | 1.3 | 1.3 |
| Example F6 | 1.2 | 1.0 | 1.3 | 2.1 | 1.7 | 1.3 |
| Example F7 | 1.2 | 1.1 | 1.0 | 1.5 | 1.2 | 1.1 |

We claim:

1. A detergent composition comprising:
a cleaning surfactant; and
a dispersant hydrophilic block copolymer, comprising:
carboxylic acid polymer segments comprising structural units of a monoethylenically unsaturated carboxylic acid monomer; and
poly(alkylene oxide) diol polymer segments, consisting of structural units of a poly(alkylene oxide) diol;
wherein 90 to 100 wt % of the poly(alkylene oxide) diol polymer segments are esterified with two structural units of monoethylenically unsaturated carboxylic acid monomer present in the carboxylic acid polymer segments per poly(alkylene oxide) diol polymer segment.

2. The detergent composition of claim 1, wherein 40 to 100 wt % of the dispersant hydrophilic block copolymer is of formula (I) 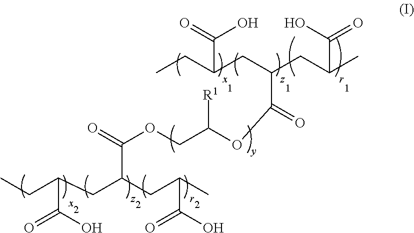
wherein z₁ is 1; wherein x₁ is 0 to 139; wherein r₁ is 0 to 139; wherein x₁+z₁+r₁=7 to 140; wherein z₂ is 1; wherein x₂ is 0 to 139; wherein r₂ is 0 to 139; wherein x₂+z₂+r₂=7 to 140; wherein each R¹ is individually selected from the group consisting of a hydrogen and a C₁₋₃ alkyl group; and wherein y is an average of 4 to 84.

3. The detergent composition of claim 2,
wherein the molar ratio of poly(alkylene oxide) diol polymer segments to carboxylic acid polymer segments in the dispersant hydrophilic block copolymer is 0.005 to 0.03;
wherein the dispersant hydrophilic block copolymer comprises 0 to 60 wt % of residual carboxylic acid polymer segments that remain unesterified with a poly(alkylene oxide) diol polymer segment; and
wherein the dispersant hydrophilic block copolymer comprises 0 to 1 wt % of residual poly(alkylene oxide) diol polymer segments that remain unesterified with a carboxylic acid polymer segment.

4. The detergent composition of claim 3, wherein the detergent composition further comprises a poly(acrylic acid) polymer.

5. The detergent composition of claim 4, wherein the detergent composition is selected from a laundry detergent and a dishwashing detergent.

6. The detergent composition of claim 5, wherein the detergent composition is an automatic dishwashing detergent composition and wherein the cleaning surfactant includes a nonionic surfactant; and wherein the automatic dishwashing detergent composition further comprises:
a builder;
a phosphonate; and
an optional additive selected from the group consisting of a carrier, a bleaching agent, a bleach activator, an enzyme, a filler and mixtures thereof.

7. The automatic dishwashing detergent composition of claim 6, wherein the automatic dishwashing detergent composition contains less than 0.1 wt %, based on weight of the automatic dishwashing detergent composition, of phosphate, measured as elemental phosphorus.

8. The automatic dishwashing detergent composition of claim 7, wherein the automatic dishwashing detergent composition contains 0 wt %, based on weight of the automatic dishwashing detergent composition, of builders selected from the group consisting of nitrilotriacetic acid; ethylenediaminetetraacetic acid; diethylenetriaminepentaacetic acid; glycine-N,N-diacetic acid; methyl glycine-N,N-diacetic acid; 2-hydroxyethyliminodiacetic acid; glutamic acid-N,N-diacetic acid; 3-hydroxy-2,2′-iminodissuccinate; S,S-ethylenediaminedisuccinate aspartic acid-diacetic acid; N,N′-ethylene diamine disuccinic acid; iminodisuccinic acid; aspartic acid; aspartic acid-N,N-diacetic acid; beta-alaninediacetic acid; polyaspartic acid; salts thereof and mixtures thereof.

9. The automatic dishwashing detergent composition of claim 8, comprising
50 to 85 wt %, based on weight of the automatic dishwashing detergent composition, of the builder, wherein the builder is selected from the group consisting of carbonates, bicarbonates, citrates, silicates and mixtures thereof;
0.75 to 7 wt %, based on weight of the automatic dishwashing detergent composition, of the phosphonate;
1.5 to 7.5 wt %, based on weight of the automatic dishwashing detergent composition, of the nonionic surfactant; and
4 to 7 wt %, based on weight of the automatic dishwashing detergent composition, of the dispersant hydrophilic block copolymer.

10. A method of cleaning an article in an automatic dishwashing detergent machine, comprising:
providing at least one article;
providing an automatic dishwashing detergent composition of claim 6; and,
applying the automatic dishwashing detergent composition to the at least one article in the automatic dishwashing detergent machine.
